(19) United States
(12) Patent Application Publication
(10) Pub. No.: US 2025/0096345 A1
(43) Pub. Date: Mar. 20, 2025

(54) TRACTION BATTERY PACK THERMAL MANAGEMENT SYSTEM AND THERMAL MANAGEMENT METHOD

(71) Applicant: Ford Global Technologies, LLC, Dearborn, MI (US)

(72) Inventor: Xiaogang Zhang, Novi, MI (US)

(21) Appl. No.: 18/469,012

(22) Filed: Sep. 18, 2023

(51) Int. Cl. H01M 10/613; H01M 10/625; H01M 10/6568; H01M 50/204

(52) U.S. Cl. CPC H01M 10/613; H01M 10/625; H01M 10/6568; H01M 50/204

(57) ABSTRACT

A traction battery pack includes an enclosure assembly, a cell stack housed within the enclosure assembly and at least partially submerged within a coolant, and a vent manifold that receives vent byproducts from the cell stack. The vent manifold is housed within the enclosure assembly and at least partially submerged within the coolant.

### TECHNICAL FIELD

This disclosure details exemplary methods and assemblies that help to manage thermal energy utilizing the coolant while also managing vent byproducts vented from battery cells within a battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. Coolant can be moved through the traction battery pack to help manage thermal energy within the traction battery pack.

### SUMMARY

In some aspects, the techniques described herein relate to a traction battery pack, including: an enclosure assembly; a cell stack housed within the enclosure assembly and at least partially submerged within a coolant; and a vent manifold that receives vent byproducts from the cell stack, the vent manifold housed within the enclosure assembly and at least partially submerged within the coolant.

In some aspects, the techniques described herein relate to a traction battery pack, wherein the coolant is a non-conductive coolant.

In some aspects, the techniques described herein relate to a traction battery pack, wherein the vent manifold is configured to convey the vent byproducts to an area outside the enclosure assembly.

In some aspects, the techniques described herein relate to a traction battery pack, wherein the vent manifold maintains the vent byproducts separate from the coolant within the enclosure assembly.

In some aspects, the techniques described herein relate to a traction battery pack, wherein the cell stack and the vent manifold directly contacts the coolant.

In some aspects, the techniques described herein relate to a traction battery pack, wherein the coolant manages thermal energy within the cell stack.

In some aspects, the techniques described herein relate to a traction battery pack, wherein the coolant is a liquid coolant.

In some aspects, the techniques described herein relate to a traction battery pack, wherein the enclosure assembly includes a tray and a cover, the enclosure tray including a bottom wall.

In some aspects, the techniques described herein relate to a traction battery pack, further including a plurality of standoffs that hold the cell stack at a position spaced from the bottom wall.

In some aspects, the techniques described herein relate to a traction battery pack, further including a plurality of busbars and a plurality of terminals of the cell stack, the plurality of busbars and the plurality of terminals at least partially submerged within the coolant.

In some aspects, the techniques described herein relate to a traction battery pack, further including a plurality of battery cells of the cell stack, each battery cell within the plurality of battery cells having a first terminal on a first side of the vent manifold and a second terminal on a different, second side of the vent manifold.

In some aspects, the techniques described herein relate to a traction battery pack, wherein the first terminal and the second terminal are at least partially submerged within the coolant.

In some aspects, the techniques described herein relate to a traction battery pack, wherein the vent manifold extends over a plurality of vents of the cell stack.

In some aspects, the techniques described herein relate to a method of managing thermal energy within a battery pack, including: directing a coolant through an enclosure assembly to manage thermal energy within a cell stack that is housed within and interior area of the enclosure assembly, the cell stack at least partially submerged within the coolant; and establish a vent path for vent byproducts to move from the cell stack to an area outside the interior area.

In some aspects, the techniques described herein relate to a method, further including immersion cooling the cell stack using the coolant.

In some aspects, the techniques described herein relate to a method, wherein the coolant is a liquid coolant.

In some aspects, the techniques described herein relate to a method, further including using a vent manifold to establish the vent path.

In some aspects, the techniques described herein relate to a method, wherein the coolant directly contacts the vent manifold.

In some aspects, the techniques described herein relate to a method, further including communicating the coolant from the enclosure assembly through a coolant outlet, and communicating the vent byproducts from the enclosure assembly through a vent byproduct outlet that is different than the coolant outlet.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective and partially expanded view of the battery pack of FIG. 1.

FIG. 3 illustrates a section view taken at line 3-3 in FIG. 2 when the battery pack is assembled.

FIG. 4 illustrates a section view taken at line 4-4 in FIG. 2 when the battery pack is assembled.

FIG. 5 illustrates a section view taken at line 5-5 in FIG. 2 when the battery pack is assembled.

### DETAILED DESCRIPTION

An immersion thermal management system can be used to manage thermal energy in a battery pack. When such a system is used, components, such as battery cells, can be at least partially immersed in coolant circulated through the traction battery pack.

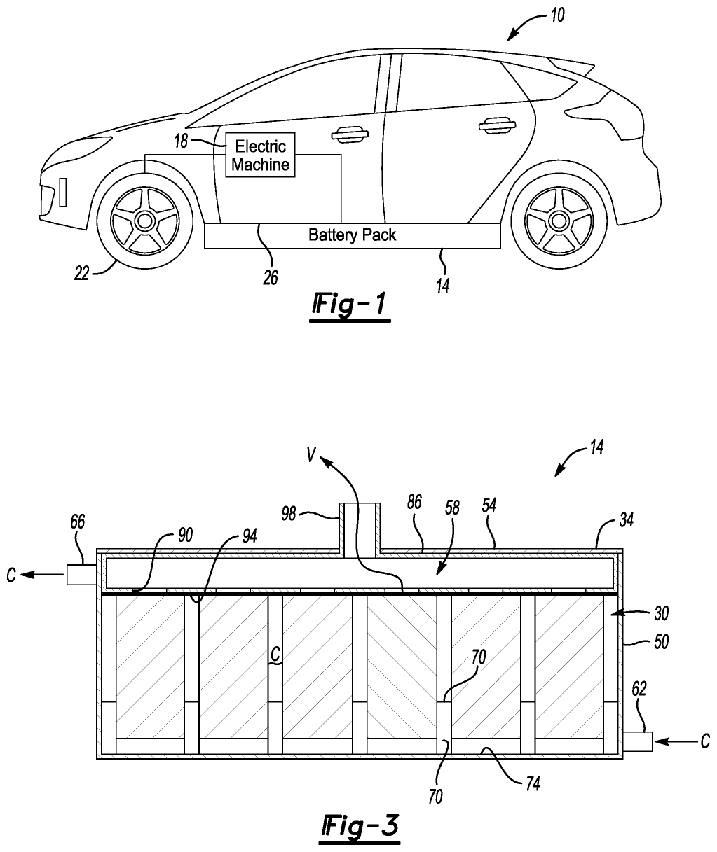

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

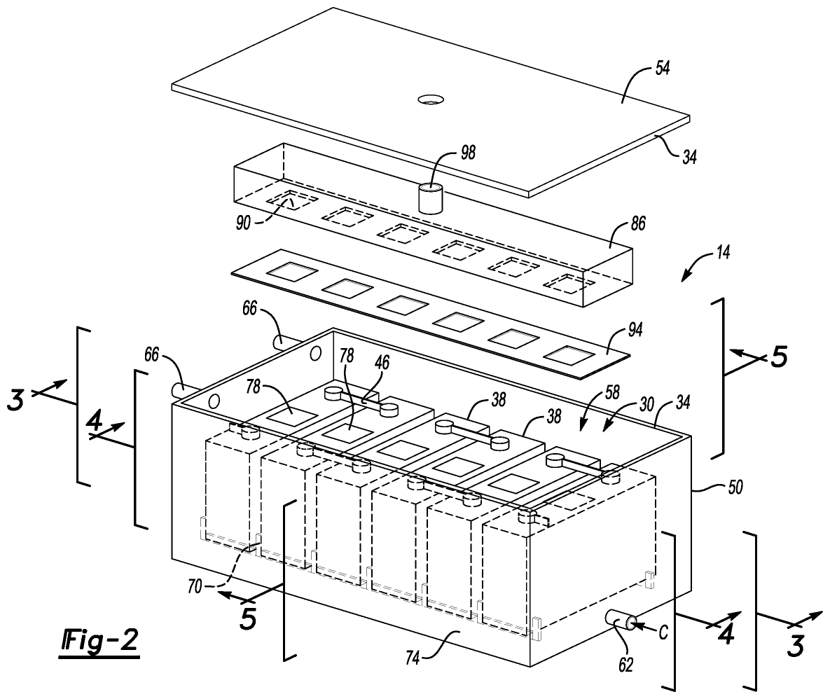

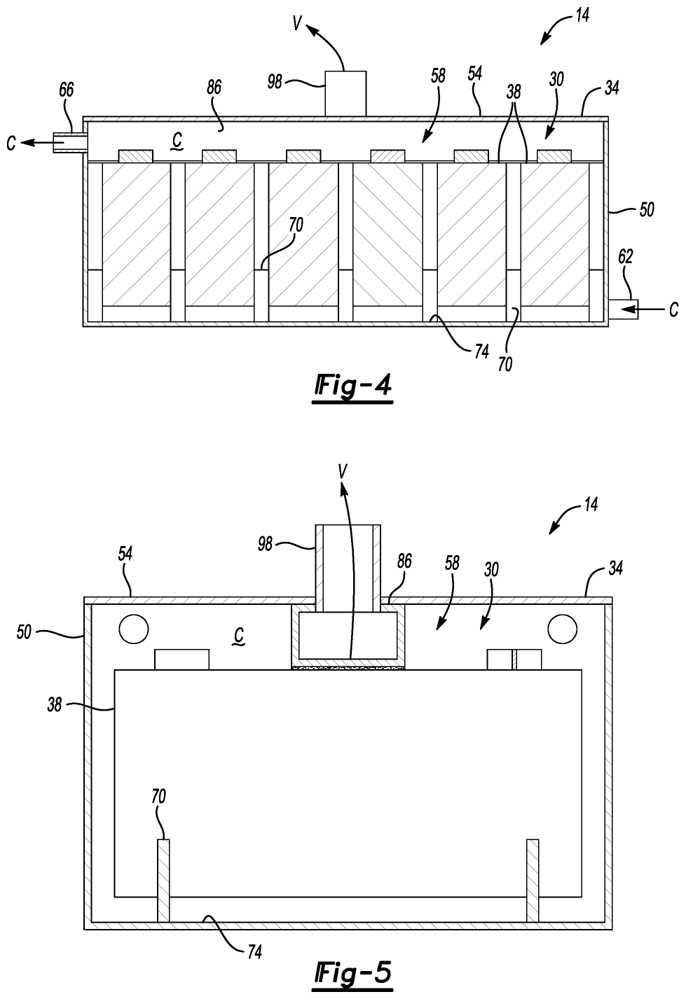

With reference now to FIGS. 2-5, and continuing reference to FIG. 1, the traction battery pack 14 includes at least one cell stack 30 housed within an enclosure assembly 34. While a highly schematic exemplary enclosure assembly 34 is shown, the enclosure assembly 34 can vary significantly in size, shape, and configuration within the scope of this disclosure.

The cell stack 30 includes a plurality of individual battery cells (or simply “cells”) 38. Each of the battery cells includes a pair of terminals 42. Busbars 46 can connect to the terminals 42 to electrically connect cells 38 within one of the cell stacks 30, to another cell stack, or to another component.

The plurality of battery cells 38, are for supplying electrical power to various components of the electrified vehicle 10. The battery cells 38 are stacked side-by-side relative to one another to provide the cell stack 30 in this example.

In the exemplary embodiment the enclosure assembly 34 includes a tray 50 and a cover 54. The cover 54 can be bolted to the tray 50. The cover 54 and the tray 50 can be connected using fluid tight connection techniques, such as adhesive or welds, in other examples.

The enclosure cover 54 is secured to the enclosure try 50 to provide an interior area 58 that houses the at least one cell stack 30. The traction battery pack 14 includes a single cell stack 30 in the figures of the exemplary embodiment. Although only one cell stack 30 is shown, the traction battery pack 14 could include any number of cells 38 and cell stacks 30. In other words, the disclosure is not limited to the specific configuration of cells 38 and cell stacks 30 shown in the figures. Further, the battery pack 14 could be combined with other battery packs 14 to provide a battery pack assembly for the vehicle 10.

In the exemplary embodiment, the battery cells 38 are lithium-ion pouch cells. However, battery cells having other geometries (cylindrical, etc.) and/or chemistries (nickel-metal hydride, lead-acid, etc.) could alternatively be utilized within the scope of this disclosure.

The example vehicle 10 incorporates a thermal management system to manage thermal energy levels of the battery cells 38, the cell stack 30, and other areas of the traction battery pack 14. The thermal management system can be used to cool the battery cells 38 of the cell stack 30. In some examples, the thermal management system could be used to heat the battery cells 38. Thermal energy levels within the battery pack 14 can increase as the vehicle 10 and the battery pack 14 are operated.

The example thermal management system delivers coolant C to the interior area 58 through a coolant inlet 62 that extends through, in this example, a wall of the tray 50. In this example, the coolant C fills open areas within the interior area 58. The cells 38, the cell stack 30, thus busbars 46, and other components within the interior area 58 are at least partially submerged within the coolant. Within the interior area 58, the coolant C can take on thermal energy from the battery cells 38, the cell stack 30, and other components of the battery pack 14.

Coolant C is communicated from the battery pack 14 through, in this example, one of two coolant outlets 66. The coolant, which has taken on thermal energy within the interior area 58, can move from one of the coolant outlets 66 to a thermal exchange device, such as a heat exchanger, where thermal energy is transferred from the coolant C to, for example, the surrounding environment. A pump can be operated to circulate the coolant C between the battery pack 14 and the thermal energy exchange device. From the thermal energy exchange device, the pump can circulate the coolant to a coolant supply, which provides coolant to the coolant inlet 62.

The coolant is a dielectric fluid in this example. The coolant can be an oil. The coolant can be non-conductive and can be a liquid that is designed for immersion cooling of battery cells 38 and cell stacks 30. The chemical makeup and design characteristics (e.g., dielectric constant, maximum breakdown strength, boiling point, etc.) of the coolant C can vary depending on the environment that the battery pack 14 is designed to be utilized in. Unlike some conductive glycol coolants utilized within cold plate cooling systems, the coolant of the exemplary embodiment is designed for immersion cooling and allows for direct contact with the battery cells 38 and other electrified components.

To provide passageways for coolant C to move within the interior area 58, the cells 38 of the exemplary cell stack 30 are supported on a plurality of standoffs 70, which raise the cells 38 from a bottom wall 74 of the tray 50. The standoffs 70 hold the cells 38 of the cell stack 30 at a position spaced from the bottom wall 74.

Coolant can move between the bottom of the cells 38 within the cell stack 30 and the bottom wall 74 when cooling the cell stack 30. The standoffs 70 have a C-shaped profile when viewed from the side and can used to align and space the cells 38 of the cell stack 30.

From time to time, pressure and thermal energy levels within one or more of the battery cells 38 can increase. The pressure and thermal energy increase can be due to an overcharge condition, for example. The pressure and thermal energy increase can cause a vent 78 within that battery cell 38 to rupture.

With the vent 78 ruptured, vent byproducts V, such as gas and debris, are then expelled from within the interior of the battery cell 38 relieving the pressure differential. Vent byproducts V are then released from the battery cell 38 through the associated vent 78 within an outer case of the battery cell 38. The vent 78 can be a membrane that yields response to increased internal pressure within the battery cell 38. The vent could instead or additionally include simply a ruptured area of an outer case of the battery cell 38.

The vent byproducts V can have a relatively high thermal energy level. In the past, immersion cooled battery cells may have permitted vent byproducts V to move directly into coolant that is immersion cooling that battery cell. Separating the vent byproducts V from the liquid coolant was then often required.

The example battery pack 14 incorporates a vent manifold 86 that is housed within the enclosure assembly 34. The vent manifold 86 extends axially along a length of the cell stack 30 in this example. The example vent manifold 86 includes a plurality of manifold openings 90 that are each aligned with one of the vents 78 within the cells 38. An insulative material 94 can be used to seal interfaces between the vent manifold 86 and the cell stack 30.

The vent manifold 86 can receive vent byproducts V expelled through the vent 78 of one of the battery cells 38. The vent manifold 86 receives the vent byproducts through one of the manifold openings 90. The vent manifold 86 establishes a vent path through the interior area 58 for the vent byproducts V. The vent manifold 86 keeps the vent byproducts V separate from the coolant C.

The vent manifold 86 receives the vent byproducts V and conveys the vent byproducts V to a vent outlet 98. The vent byproducts V are communicated from the enclosure assembly 34 through the vent outlet 98, which is separate from the coolant outlets 66. The vent manifold 86 helps to guide the vent byproducts V away from battery cells 38 that are not venting, which can help to prevent a thermal vent from cascading through the battery cells 38 of the cell stack 30 that are not venting.

Vent byproducts V move through the vent outlet 98 to an area outside the enclosure assembly 34. Notably, the vent byproducts V are conveyed from one of the battery cells 38 to the vent outlet 98 without comingling with any of the coolant C within the interior area 58. The vent manifold 86 compartmentalizes some of the interior area 58 to keep the vent byproducts V separate from the coolant C within the interior area 58.

The coolant C can directly contact the sides of the vent manifold 86. This may facilitate the coolant C taking on some thermal energy from the vent byproducts V within the vent manifold 86 prior to the vent byproducts V moving through the vent outlet 98. Cooling the vent byproducts V with the coolant C can reduce a temperature of the vent byproducts V prior to the vent byproducts V being expelled from the enclosure assembly 34.

Features of the disclosed examples include a battery pack that incorporates a thermal management system directing a coolant through an enclosure assembly to manage thermal energy within, among other things, a cell stack of the battery pack. The thermal management system keeps vent byproducts separate from the coolant.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack, comprising:
an enclosure assembly;
a cell stack housed within the enclosure assembly and at least partially submerged within a coolant; and
a vent manifold that receives vent byproducts from the cell stack, the vent manifold housed within the enclosure assembly and at least partially submerged within the coolant.

2. The traction battery pack of claim 1, wherein the coolant is a non-conductive coolant.

3. The traction battery pack of claim 1, wherein the vent manifold is configured to convey the vent byproducts to an area outside the enclosure assembly.

4. The traction battery pack of claim 1, wherein the vent manifold maintains the vent byproducts separate from the coolant within the enclosure assembly.

5. The traction battery pack of claim 1, wherein the cell stack and the vent manifold directly contacts the coolant.

6. The traction battery pack of claim 1, wherein the coolant manages thermal energy within the cell stack.

7. The traction battery pack of claim 1, wherein the coolant is a liquid coolant.

8. The traction battery pack of claim 1, wherein the enclosure assembly includes a tray and a cover, the enclosure tray including a bottom wall.

9. The traction battery pack of claim 8, further comprising a plurality of standoffs that hold the cell stack at a position spaced from the bottom wall.

10. The traction battery pack of claim 1, further comprising a plurality of busbars and a plurality of terminals of the cell stack, the plurality of busbars and the plurality of terminals at least partially submerged within the coolant.

11. The traction battery pack of claim 1, further comprising a plurality of battery cells of the cell stack, each battery cell within the plurality of battery cells having a first terminal on a first side of the vent manifold and a second terminal on a different, second side of the vent manifold.

12. The traction battery pack of claim 11, wherein the first terminal and the second terminal are at least partially submerged within the coolant.

13. The traction battery pack of claim 11, wherein the vent manifold extends over a plurality of vents of the cell stack.

14. A method of managing thermal energy within a battery pack, comprising:
directing a coolant through an enclosure assembly to manage thermal energy within a cell stack that is housed within and interior area of the enclosure assembly, the cell stack at least partially submerged within the coolant; and
establish a vent path for vent byproducts to move from the cell stack to an area outside the interior area.

15. The method of claim 14, further comprising immersion cooling the cell stack using the coolant.

16. The method of claim 14, wherein the coolant is a liquid coolant.

17. The method of claim 14, further comprising using a vent manifold to establish the vent path.

18. The method of claim 17, wherein the coolant directly contacts the vent manifold.

19. The method of claim 14, further comprising communicating the coolant from the enclosure assembly through a coolant outlet, and communicating the vent byproducts from the enclosure assembly through a vent byproduct outlet that is different than the coolant outlet.
